(19) United States
(12) Patent Application Publication
(10) Pub. No.: US 2024/0094342 A1
(43) Pub. Date: Mar. 21, 2024

(54) RADAR INSTALLATION ANGLE ADJUSTMENT ASSISTANCE DEVICE AND COMPUTER PROGRAM

(71) Applicant: Sumitomo Electric Industries, Ltd., Osaka-shi, Osaka (JP)

(72) Inventor: Eiji MOCHIDA, Osaka-shi, Osaka (JP)

(73) Assignee: Sumitomo Electric Industries, Ltd., Osaka-shi, Osaka (JP)

(21) Appl. No.: 18/273,547

(22) PCT Filed: Nov. 10, 2021
(86) PCT No.: PCT/JP2021/041375

§ 371 Date: Jul. 21, 2023

(30) Foreign Application Priority Data
Feb. 3, 2021 (JP) 2021-015579

(51) Int. Cl. G01S 7/40

(52) U.S. Cl. CPC G01S 7/4026

(57) ABSTRACT

A radar installation angle adjustment assistance apparatus includes: a display device; and a display control unit configured to cause the display device to display an assistance screen for assisting adjustment of an installation angle of an infrastructure radar. The assistance screen includes a target value display part configured to display a target value of the installation angle of the infrastructure radar, a detection angle display part configured to display the installation angle of the infrastructure radar detected by an angle sensor, and a determination result display part configured to display a determination result of determination as to whether or not an angle difference between the target value and the installation angle is included in a predetermined set range. When the angle difference is not included in the predetermined set range, the display control unit causes an angle based on the angle difference to be displayed on the assistance screen.

### TECHNICAL FIELD

The present disclosure relates to a radar installation angle adjustment assistance apparatus and a computer program. This application claims priority on Japanese Patent Application No. 2021-015579 filed on Feb. 3, 2021, the entire content of which is incorporated herein by reference.

### BACKGROUND ART

PATENT LITERATURE 1 discloses an axis adjustment apparatus that performs axis adjustment for an in-vehicle radar mounted in a vehicle.

### CITATION LIST

### Patent Literature

PATENT LITERATURE 1: Japanese Laid-Open Patent Publication No. 2015-68746

### SUMMARY OF THE INVENTION

A radar installation angle adjustment assistance apparatus according to an aspect of the present disclosure includes: a display device; and a display control unit configured to cause the display device to display an assistance screen for assisting adjustment of an installation angle of an infrastructure radar configured to detect an object present in a target area through transmission and reception of a radio wave. The assistance screen includes a target value display part configured to display a target value of the installation angle of the infrastructure radar, a detection angle display part configured to display the installation angle of the infrastructure radar detected by an angle sensor configured to detect the installation angle, and a determination result display part configured to display a determination result of determination as to whether or not an angle difference between the target value displayed in the target value display part and the installation angle displayed in the detection angle display part is included in a predetermined set range. When the angle difference is not included in the predetermined set range, the display control unit causes an angle based on the angle difference to be displayed on the assistance screen.

A computer program according to an aspect of the present disclosure is for causing a computer including a display device, to execute a process of assisting adjustment of an installation angle of an infrastructure radar configured to detect an object present in a target area through transmission and reception of a radio wave. The process includes: a process of causing the computer to cause the display device to display an assistance screen for assisting adjustment of the installation angle of the infrastructure radar. The assistance screen includes a target value display part configured to display a target value of the installation angle of the infrastructure radar, a detection angle display part configured to display the installation angle of the infrastructure radar detected by an angle sensor configured to detect the installation angle, and a determination result display part configured to display a determination result of determination as to whether or not an angle difference between the target value displayed in the target value display part and the installation angle displayed in the detection angle display part is included in a predetermined set range. When the angle difference is not included in the predetermined set range, an angle based on the angle difference is caused to be displayed on the assistance screen.

The present disclosure can be realized not only as a radar installation angle adjustment assistance apparatus including the characteristic configuration as described above, but also as: a display control apparatus that controls the characteristic screen display in the radar installation angle adjustment assistance apparatus; a radar installation angle adjustment assistance method that includes the characteristic process steps of the radar installation angle adjustment assistance apparatus; or a computer program that causes a computer to execute the method as described above.

### BRIEF DESCRIPTION OF DRAWINGS

FIG. 1 shows a use example of a radar according to an embodiment.

FIG. 2 is a perspective view showing an example of an external configuration of a radar according to a first embodiment.

FIG. 3 is a block diagram showing an example of a configuration of a radar installation angle adjustment assistance apparatus according to the first embodiment.

FIG. 4 is a flowchart showing an example of an operation procedure of the radar installation angle adjustment assistance apparatus according to the first embodiment.

FIG. 5A shows an example of an assistance screen according to the first embodiment.

FIG. 5B shows another example of the assistance screen according to the first embodiment.

FIG. 6 is a perspective view showing an example of an external configuration of a radar according to a second embodiment.

FIG. 7 is a block diagram showing an example of a configuration of a radar installation angle adjustment assistance apparatus according to the second embodiment.

FIG. 8 is a flowchart showing an example of an operation procedure of the radar installation angle adjustment assistance apparatus according to the second embodiment.

FIG. 9A is a diagram showing an example of an assistance screen according to the second embodiment.

FIG. 9B is a diagram showing another example of the assistance screen according to the second embodiment.

### DETAILED DESCRIPTION

### Problems to be Solved by the Present Disclosure

Radars are also used in traffic monitoring at intersections, roads, and the like. A radar for traffic monitoring (hereinafter, also referred to as “infrastructure radar” is installed by a person in charge of construction at an intersection or a road, and the angle of the installed radar is adjusted by a person in charge of adjustment. At the time of installation by the person in charge of construction, no power supply is connected to the radar, and further, the person in charge of construction does not have knowledge about angle adjustment of the radar. Thus, it is difficult for the person in charge of construction to perform adjustment. The installed radar is supplied with power at the adjustment stage, and the person in charge of adjustment adjusts the angle such that the application axis is directed to an appropriate direction, while confirming output. However, radars installed by the person in charge of construction have varied angles, and the optimum angles are different for respective installation places. Therefore, in order to perform accurate adjustment, radars need to be dismounted once and installed again in some cases, which makes the adjustment complicated.

### Effects of the Present Disclosure

According to the present disclosure, it is possible to assist adjustment of the installation angle of a radar for traffic monitoring.

### Outline of Embodiment of the Present Disclosure

Hereinafter, outlines of embodiments of the present disclosure will be listed and described.

(1) A radar installation angle adjustment assistance apparatus according to the present embodiment includes: a display device; and a display control unit configured to cause the display device to display an assistance screen for assisting adjustment of an installation angle of an infrastructure radar configured to detect an object present in a target area through transmission and reception of a radio wave. The assistance screen includes a target value display part configured to display a target value of the installation angle of the infrastructure radar, a detection angle display part configured to display the installation angle of the infrastructure radar detected by an angle sensor configured to detect the installation angle, and a determination result display part configured to display a determination result of determination as to whether or not an angle difference between the target value displayed in the target value display part and the installation angle displayed in the detection angle display part is included in a predetermined set range. When the angle difference is outside the predetermined set range, the display control unit causes an angle based on the angle difference to be displayed on the assistance screen. A user can adjust the installation angle of the infrastructure radar by confirming the angle based on the angle difference on the assistance screen. Therefore, adjustment of the installation angle of the infrastructure radar by the user can be assisted.

(2) The installation angle may include at least one of a horizontal angle, a depression angle, and a roll angle of the infrastructure radar, and the display control unit may cause at least one of the horizontal angle, the depression angle, and the roll angle of the infrastructure radar, to be displayed in the detection angle display part. Accordingly, adjustment of at least one of the horizontal angle, the depression angle, and the roll angle of the infrastructure radar can be assisted.

(3) The angle based on the angle difference may include an angle for correcting at least one of the horizontal angle, the depression angle, and the roll angle of the infrastructure radar. The display control unit may cause the angle for correcting at least one of the horizontal angle, the depression angle, and the roll angle of the infrastructure radar, to be displayed on the assistance screen. Accordingly, the user can appropriately correct at least one of the horizontal angle, the depression angle, and the roll angle of the infrastructure radar by confirming the angle based on the angle difference.

(4) The radar installation angle adjustment assistance apparatus may further include a reception unit configured to receive angle data indicating an angle detected by the angle sensor. The display control unit may update display of the angle based on the angle difference every time the angle data is received by the reception unit, and may switch display in the determination result display part from the angle based on the angle difference to positive information indicating that the angle difference is included in the predetermined set range, when the angle difference has changed so as to be included in the set range. Accordingly, the user can easily and appropriately adjust the installation angle by correcting, in accordance with the assistance screen, the installation angle of the infrastructure radar until the display in the determination result display part is switched from the angle based on the angle difference to the positive information.

(5) A display color for displaying the angle based on the angle difference and a display color for displaying the positive information may be different from each other. Accordingly, the user can easily confirm switching from the angle based on the angle difference to the positive information in the determination result display part.

(6) The assistance screen may further include an installation height display part configured to display an installation height of the infrastructure radar, and the display control unit may cause the target value of the installation angle calculated based on the installation height displayed in the installation height display part, to be displayed in the target value display part. Accordingly, an appropriate target value of the installation angle according to the installation height of the infrastructure radar can be presented to the user.

(7) The assistance screen may further include an installation position information display part configured to display installation position information indicating an installation position of the infrastructure radar, and a target position information display part configured to display target position information indicating a target value of a radio wave application position of the infrastructure radar. The display control unit may cause the target value of the installation angle calculated based on the installation position information displayed in the installation position information display part, the target position information displayed in the target position information display part, and the installation height displayed in the installation height display part, to be displayed in the target value display part. Accordingly, an appropriate target value of the installation angle according to the installation position of the infrastructure radar, the target value of the radio wave application position of the infrastructure radar, and the installation height of the infrastructure radar can be presented to the user.

(8) The display control unit may cause the installation position information indicating a position of the infrastructure radar detected by a position sensor configured to detect the position, to be displayed in the installation position information display part. Accordingly, the target value of the installation angle of the infrastructure radar can be determined by using accurate installation position information of the infrastructure radar detected by the position sensor.

(9) A computer program according to the present embodiment is for causing a computer including a display device, to execute a process of assisting adjustment of an installation angle of an infrastructure radar configured to detect an object present in a target area through transmission and reception of a radio wave. The process includes a process of causing the computer to cause the display device to display an assistance screen for assisting adjustment of the installation angle of the infrastructure radar. The assistance screen includes a target value display part configured to display a target value of the installation angle of the infrastructure radar, a detection angle display part configured to display the installation angle of the infrastructure radar detected by an angle sensor configured to detect the installation angle, and a determination result display part configured to display a determination result of determination as to whether or not an angle difference between the target value displayed in the target value display part and the installation angle displayed in the detection angle display part is included in a predetermined set range. When the angle difference is outside the predetermined set range, an angle based on the angle difference is caused to be displayed on the assistance screen. The user can adjust the installation angle of the infrastructure radar by confirming the angle based on the angle difference on the assistance screen. Therefore, adjustment of the installation angle of the infrastructure radar by the user can be assisted.

(10) The installation angle may include at least one of a horizontal angle, a depression angle, and a roll angle of the infrastructure radar, and the process of causing the display device to display the assistance screen may cause at least one of the horizontal angle, the depression angle, and the roll angle of the infrastructure radar, to be displayed in the detection angle display part. Accordingly, adjustment of at least one of the horizontal angle, the depression angle, and the roll angle of the infrastructure radar can be assisted.

(11) The angle based on the angle difference may include an angle for correcting at least one of the horizontal angle, the depression angle, and the roll angle of the infrastructure radar, and the process of causing the display device to display the assistance screen may cause the angle for correcting at least one of the horizontal angle, the depression angle, and the roll angle of the infrastructure radar, to be displayed on the assistance screen. Accordingly, the user can appropriately correct at least one of the horizontal angle, the depression angle, and the roll angle of the infrastructure radar by confirming the angle based on the angle difference.

(12) The process of causing the display device to display the assistance screen may include a process of: updating display of the angle based on the angle difference every time angle data indicating a detected angle is provided from the angle sensor; and sw % itching display in the determination result display part from the angle based on the angle difference to positive information indicating that the angle difference is included in the predetermined set range, when the angle difference has changed so as to be included in the set range. Accordingly, the user can easily and appropriately adjust the installation angle by correcting, in accordance with the assistance screen, the installation angle of the infrastructure radar until the display in the determination result display part is switched from the angle based on the angle difference to the positive information.

(13) A display color for displaying the angle based on the angle difference and a display color for displaying the positive information may be different from each other. Accordingly, the user can easily confirm switching from the angle based on the angle difference to the positive information in the determination result display part.

(14) The assistance screen may further include an installation height display part configured to display an installation height of the infrastructure radar, and the process of causing the display device to display the assistance screen may cause the target value of the installation angle calculated based on the installation height displayed in the installation height display part, to be displayed in the target value display part. Accordingly, an appropriate target value of the installation angle according to the installation height of the infrastructure radar can be presented to the user.

(15) The assistance screen may further include an installation position information display part configured to display installation position information indicating an installation position of the infrastructure radar, and a target position information display part configured to display target position information indicating a target value of a radio wave application position of the infrastructure radar. The process of causing the display device to display the assistance screen may cause the target value of the installation angle calculated based on the installation position information displayed in the installation position information display part, the target position information displayed in the target position information display part, and the installation height displayed in the installation height display part, to be displayed in the target value display part. Accordingly, an appropriate target value of the installation angle according to the installation position of the infrastructure radar, the target value of the radio wave application position of the infrastructure radar, and the installation height of the infrastructure radar can be presented to the user.

(16) The process of causing the display device to display the assistance screen may cause the installation position information indicating a position of the infrastructure radar detected by a position sensor configured to detect the position, to be displayed in the installation position information display part. Accordingly, the target value of the installation angle of the infrastructure radar can be determined by using accurate installation position information of the infrastructure radar detected by the position sensor.

### Details of Embodiment of the Present Disclosure

Hereinafter, embodiments of the present disclosure will be described in detail with reference to the drawings. At least some parts of the embodiments described below may be combined together as desired.

### First Embodiment

[1-1. Radar]

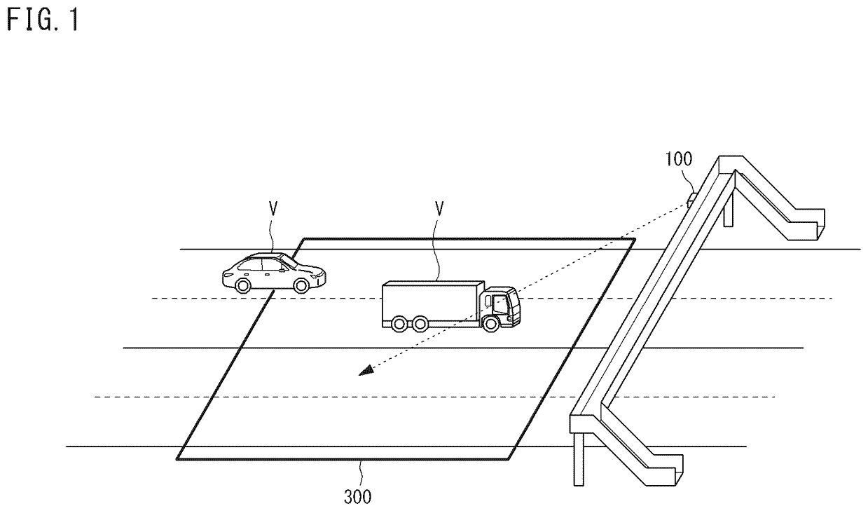

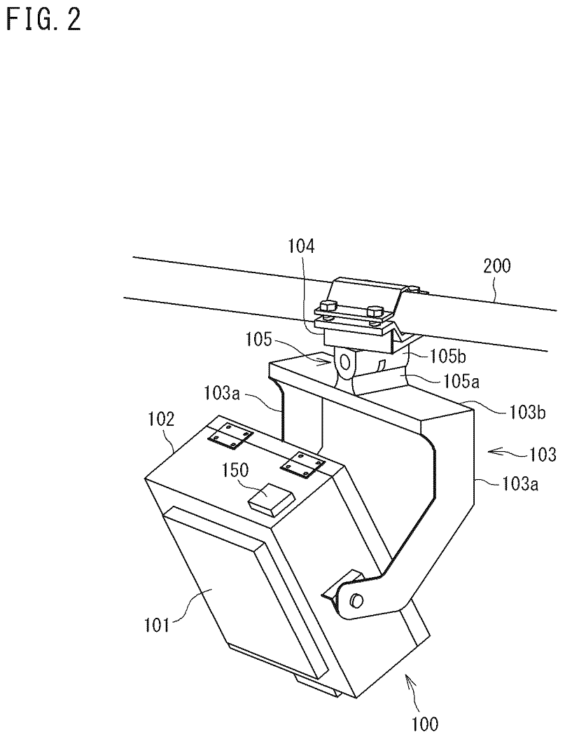

FIG. 1 shows a use example of a radar according to an embodiment. A radar 100 according to the present embodiment is a radio wave radar (infrastructure radar) for traffic monitoring. The radar 100 is mounted to an arm 200 (see FIG. 2) or the like provided at an intersection or a road. The radar 100 is a millimeter wave radar and is a radio wave sensor. The radar 100 applies a radio wave (millimeter wave) to a target area 300 on the road and receives a reflected wave thereof, thereby detecting an object (e.g., vehicle V) in the target area 300. More specifically, the radar 100 can detect the distance to the vehicle V traveling on the road, the speed of the vehicle V, and the horizontal angle, of the position where the vehicle V is present, with respect to the radio wave application axis of the radar.

The radar 100 is installed such that the direction (the direction indicated by a broken line in FIG. 1. Hereinafter, referred to as “reference direction”) is directed to the target area 300. If the reference direction is not accurately directed to the target area 300, an object in the target area 300 cannot be accurately detected by the radar 100. Therefore, in the present embodiment, the angle of the radar 100 is adjusted such that the reference direction is directed to the target area 300, by using a radar installation angle adjustment assistance apparatus as described below.

FIG. 2 is a perspective view showing an example of an external configuration of the radar 100 according to a first embodiment. As shown in FIG. 2, the radar 100 has a transmission/reception face 101 which transmits/receives a millimeter wave. The reference direction is a direction normal to the transmission/reception face 101. The radar 100 has built therein at least one transmission antenna and a plurality of (e.g., two) reception antennas (not shown). The radar 100 transmits a modulated wave, which is a millimeter wave, from the transmission antenna through the transmission/reception face 101. The modulated wave hits an object to be reflected and the reception antennas receive the reflected wave. The radar 100 performs signal processing on a transmission wave signal and a reception wave signal by a signal processing circuit (not shown), and detects the distance to the object and the angle at which the object is present (hereinafter, referred to as “object position”), and the speed of the object.

The radar 100 is configured to be able to adjust the installation angle thereof. The radar 100 includes a radar body 102, a depression angle adjustment part 103, a horizontal angle adjustment part 104, and a roll angle adjustment part 105. The radar body 102 is formed in a box shape, and the depression angle adjustment part 103 is mounted to side faces of the radar body 102. The depression angle adjustment part 103 includes a pair of arms 103a and a coupling part 103b coupling the pair of arms 103a. The pair of respective arms 103a is rotatable about a horizontal axis parallel to the transmission/reception face 101, at side faces on both sides of the radar body 102. The radar body 102 is rotatable about a horizontal axis by the depression angle adjustment part 103, and thus, the depression angle of the radar body 102 is adjusted.

The coupling part 103b is connected to the roll angle adjustment part 105. The roll angle adjustment part 105 includes a lower member 105a and an upper member 105b, and the lower member 105a and the upper member 105b are rotatable with respect to each other about a horizontal rotation axis extending in a direction orthogonal to the longitudinal direction of the coupling part 103b. The lower member 105a is fixed to the upper face of the coupling part 103b. The radar body 102 connected to the roll angle adjustment part 105 through the depression angle adjustment part 103 is rotatable about the above-mentioned horizontal rotation axis by the roll angle adjustment part 105, and thus, the roll angle of the radar body 102 is adjusted.

The upper member 105b of the roll angle adjustment part 105 is connected to the horizontal angle adjustment part 104. The horizontal angle adjustment part 104 is fixed to a pole which is the installation target. The horizontal angle adjustment part 104 is rotatable about a vertical axis, at the upper face of the upper member 105b. The radar body 102 connected to the horizontal angle adjustment part 104 through the depression angle adjustment part 103 and the roll angle adjustment part 105 is rotatable about the vertical axis by the horizontal angle adjustment part 104, and thus, the horizontal angle of the radar body 102 is adjusted.

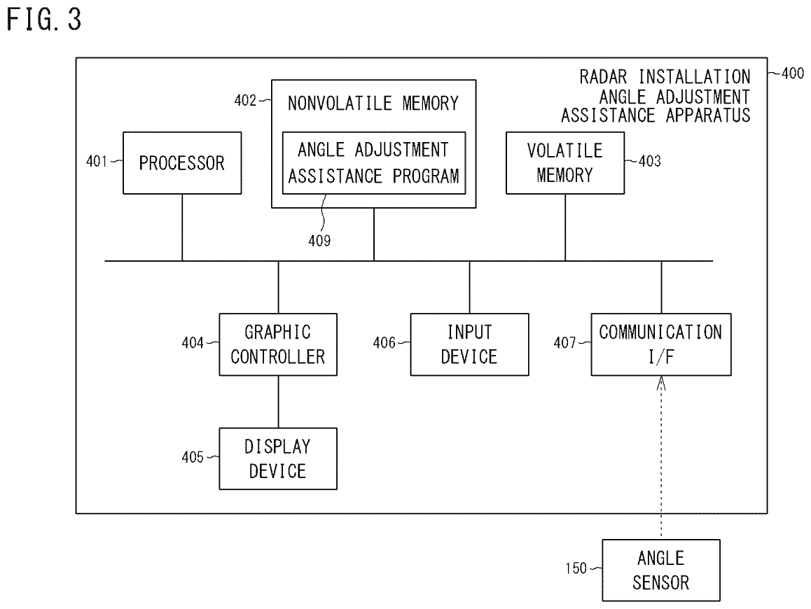

The radar body 102 is provided with an angle sensor 150. The angle sensor 150 can detect the horizontal angle, the depression angle, and the roll angle of the radar body 102. As shown in FIG. 3, the angle sensor 150 is connected to the radar installation angle adjustment assistance apparatus 400 in a wired or wireless manner. Data (hereinafter, referred to as “angle data”) of the detection value of the angle sensor 150 is transmitted to the radar installation angle adjustment assistance apparatus 400. The radar installation angle adjustment assistance apparatus 400 can display, on a display device, an assistance screen including the horizontal angle, the depression angle, and the roll angle detected by the angle sensor 150. The assistance screen includes target values of the horizontal angle, the depression angle, and the roll angle of the radar 100. A user can adjust the angle of the radar 100 while confirming the assistance screen.

[1-2. Configuration of Radar Installation Angle Adjustment Assistance Apparatus]

FIG. 3 is a block diagram showing an example of a configuration of the radar installation angle adjustment assistance apparatus according to the first embodiment. The radar installation angle adjustment assistance apparatus 400 is implemented as a portable information terminal such as a smartphone, a tablet, or a portable computer. The radar installation angle adjustment assistance apparatus 400 includes a processor 401, a nonvolatile memory 402, a volatile memory 403, a graphic controller 404, a display device 405, an input device 406, and a communication interface (communication I/F) 407.

The volatile memory 403 is a semiconductor memory such as an SRAM (Static Random Access Memory) or a DRAM (Dynamic Random Access Memory), for example. The nonvolatile memory 402 is a flash memory, a hard disk, a ROM (Read Only Memory), or the like, for example. The nonvolatile memory 402 has stored therein an angle adjustment assistance program 409 as a computer program, and data to be used in execution of the angle adjustment assistance program 409. The radar installation angle adjustment assistance apparatus 400 is configured to include a computer, and each function of the radar installation angle adjustment assistance apparatus 400 is exhibited when the angle adjustment assistance program 409 as a computer program stored in a storage device of the computer is executed by the processor 401. The angle adjustment assistance program 409 can be stored in a storage medium such as a flash memory, a ROM, or a CD-ROM. The processor 401 executes the angle adjustment assistance 409, and causes the display device 405 to display an assistance screen as described later.

The processor 401 is a CPU (Central Processing Unit), for example. However, the processor 401 is not limited to a CPU. The processor 401 may be a GPU (Graphics Processing Unit). The processor 401 may be an ASIC (Application Specific Integrated Circuit), or may be a programmable logic device such as an FPGA (Field Programmable Gate Array), for example. In this case, the ASIC or the programmable logic device is configured to be able to execute processing similar to that of the angle adjustment assistance program 409.

The graphic controller 404 is an example of a display control unit. The graphic controller 404 is connected to the display device 405 and controls display on the display device 405. The graphic controller 404 includes, for example, a GPU and a VRAM (Video RAM), keeps data to be displayed on the display device 405 in the VRAM, periodically reads out video data corresponding to one frame from the VRAM, and generates a video signal. The generated video signal is outputted to the display device 405, and a video is displayed on the display device 405. The function of the graphic controller 404 may be included in the processor 401. A partial region of the volatile memory 403 may be used as the VRAM.

The display device 405 includes a liquid crystal panel or an OEL (organic electroluminescence) panel. The display device 405 can display information of characters or figures. The input device 406 includes a touch pad of a capacitance type or a pressure-sensitive type superposed on the display device 405. The input device 406 may be a pointing device such as a keyboard or a mouse. The input device 406 is used for inputting information to the radar installation angle adjustment assistance apparatus 400.

The communication 1F 407 can communicate with an external device through wired or wireless communication. The communication I/F 407 can receive angle data transmitted from the angle sensor 150.

[1-3. Operation of Radar Installation Angle Adjustment Assistance Apparatus]

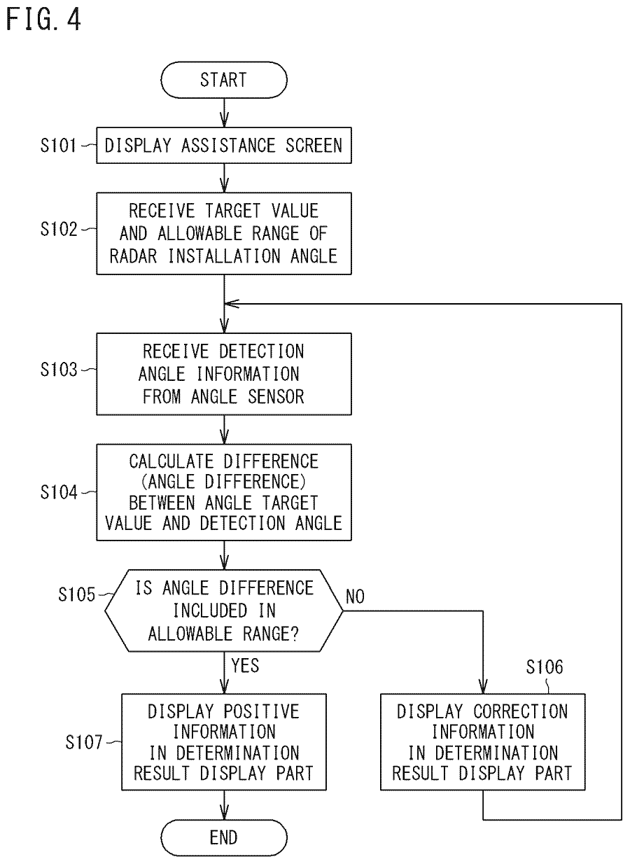

FIG. 4 is a flowchart showing an example of an operation procedure of the radar installation angle adjustment assistance apparatus 400 according to the first embodiment. When the processor 401 has activated the angle adjustment assistance program 409, the radar installation angle adjustment assistance apparatus 400 executes the operation as described below.

The processor 401 causes the display device 405 to display an assistance screen for assisting adjustment of the installation angle of the radar 100 (step S101).

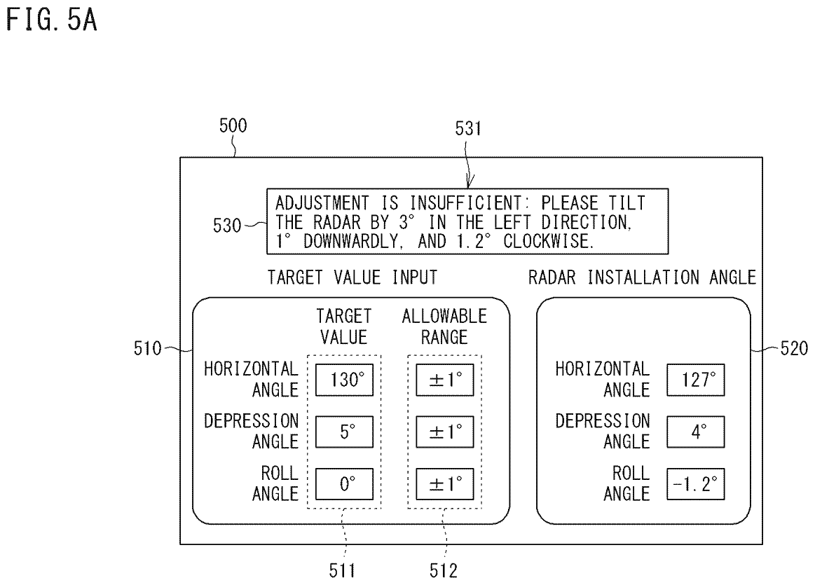

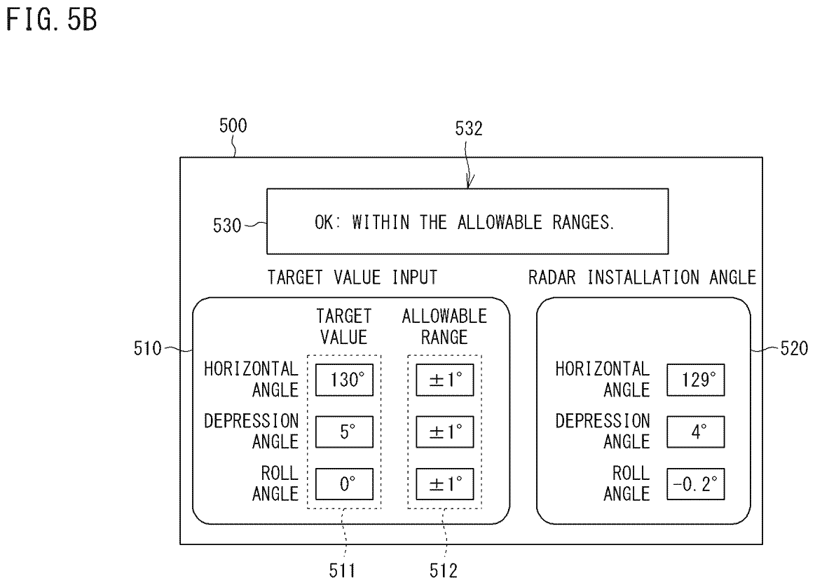

FIG. 5A and FIG. 5B each show an example of the assistance screen according to the first embodiment. As shown in FIG. 5A and FIG. 5B, an assistance screen 500 includes a target value input part 510, a detection angle display part 520, and a determination result display part 530.

The target value input part 510 is a region for inputting a target value of the installation angle (horizontal angle, depression angle, and roll angle) of the radar 100. The target value input part 510 includes a target value display part 511 and an allowable range display part 512.

The target value display part 511 is a region for displaying the target value of the installation angle of the radar 100. The target value display part 511 includes input boxes for the horizontal angle, the depression angle, and the roll angle. The user can input a target value of each of the horizontal angle, the depression angle, and the roll angle into a corresponding input box. The inputted target values of the horizontal angle, the depression angle, and the roll angle are displayed in the respective input boxes.

The allowable range display part 512 is a region for displaying an allowable range (set range) in which the installation angle of the radar is allowed to be deviated from the target value. The allowable range display part 512 includes input boxes for respective allowable ranges of the horizontal angle, the depression angle, and the roll angle. The user can input an allowable range for each of the horizontal angle, the depression angle, and the roll angle into a corresponding input box. The inputted respective allowable ranges of the horizontal angle, the depression angle, and the roll angle are displayed in the respective input boxes.

In the target value display part 511, the input boxes for the respective target values of the horizontal angle, the depression angle, and the roll angle are disposed so as to be arranged in order in the vertical direction. In the allowable range display part 512, the input boxes for the respective allowable ranges of the horizontal angle, the depression angle, and the roll angle are disposed so as to be arranged in order in the vertical direction. Accordingly, the user is inhibited from confusing the input boxes for the respective target values of the horizontal angle, the depression angle, and the roll angle, and the input boxes for the respective allowable ranges of the horizontal angle, the depression angle, and the roll angle. Since the arrangement order of the input boxes for the target values of the horizontal angle, the depression angle, and the roll angle is determined, the user is inhibited from confusing the input boxes for target values between the horizontal angle, the depression angle, and the roll angle. Since the arrangement order of the input boxes for the allowable ranges of the horizontal angle, the depression angle, and the roll angle is determined, the user is inhibited from confusing the input boxes for allowable ranges between the horizontal angle, the depression angle, and the roll angle. Further, the arrangement order of the input boxes for the horizontal angle, the depression angle, and the roll angle is unified between the target value display part 511 and the allowable range display part 512. Therefore, the user can easily memorize this arrangement order, and can easily input and confirm the target value and the allowable range of each of the horizontal angle, the depression angle, and the roll angle.

The target value display part 511 and the allowable range display part 512 are disposed at positions adjacent to each other in the lateral direction. The input box for the target value of the horizontal angle in the target value display part 511 and the input box for the allowable range of the horizontal angle in the allowable range display part 512 are disposed at positions adjacent to each other in the lateral direction. The input box for the target value of the depression angle in the target value display part 511 and the input box for the allowable range of the depression angle in the allowable range display part 512 are disposed at positions adjacent to each other in the lateral direction. The input box for the target value of the roll angle in the target value display part 511 and the input box for the allowable range of the roll angle in the allowable range display part 512 are disposed at positions adjacent to each other in the lateral direction. Therefore, the user can easily input and confirm the target value and the allowable range of each of the horizontal angle, the depression angle, and the roll angle, in association with each other.

FIG. 4 is referred to again. The user inputs the target value and the allowable range of the installation angle (horizontal angle, depression angle, and roll angle) of the radar 100 into the target value input part 510. The radar installation angle adjustment assistance apparatus 400 receives the target value and the allowable range of the installation angle of the radar 100 (step S102).

The angle sensor 150 detects the horizontal angle, the depression angle, and the roll angle of the radar 100, and transmits angle data. The radar installation angle adjustment assistance apparatus 400 receives the angle data from the angle sensor 150 (step S103). The received detected angles are displayed in the detection angle display part 520 on the assistance screen 500.

FIG. 5A and FIG. 5B are referred to again. The detection angle display part 520 is a region for displaying the angle (horizontal angle, depression angle, and roll angle) detected by the angle sensor 150 provided to the radar 100 having been installed. The detection angle display part 520 includes display boxes for the horizontal angle, the depression angle, and the roll angle. The detection angles of the horizontal angle, the depression angle, and the roll angle detected by the angle sensor 150 are displayed in the respective display boxes.

In the detection angle display part 520, the display boxes for the respective detection angles of the horizontal angle, the depression angle, and the roll angle are disposed so as to be arranged in order in the vertical direction. Since the arrangement order of the display boxes for the detection angles of the horizontal angle, the depression angle, and the roll angle is determined, the user is inhibited from confusing the detection angles between the horizontal angle, the depression angle, and the roll angle. Further, the arrangement order of the display boxes for the detection angles of the horizontal angle, the depression angle, and the roll angle in the detection angle display part 520 and the arrangement order of the input boxes for the target values of the horizontal angle, the depression angle, and the roll angle in the target value display part 511 are unified. Therefore, the user can easily memorize this arrangement order, and can easily confirm the target value and the detection angle of each of the horizontal angle, the depression angle and the roll angle.

The target value input part 510 and the detection angle display part 520 are disposed at positions adjacent to each other in the lateral direction. The respective input boxes for the target value and the allowable range of the horizontal angle in the target value input part 510 and the display box for the detection angle of the horizontal angle in the detection angle display part 520 are disposed at positions (i.e., at the same height) adjacent to each other in the lateral direction. The respective input boxes for the target value and the allowable range of the depression angle in the target value input part 510 and the display box for the detection angle of the depression angle in the detection angle display part 520 are disposed at positions adjacent to each other in the lateral direction. The respective input boxes for the target value and the allowable range of the roll angle in the target value input part 510 and the display box for the detection angle of the roll angle in the detection angle display part 520 are disposed at positions adjacent to each other in the lateral direction. Therefore, the user can easily compare the target value and the allowable range of each of the horizontal angle, the depression angle, and the roll angle, with the detection angle of each of the horizontal angle, the depression angle, and the roll angle.

FIG. 4 is referred to again. The processor 401 calculates the difference (angle difference) between the target value of each of the horizontal angle, the depression angle, and the roll angle provided from the user and the detection value of each of the horizontal angle, the depression angle, and the roll angle detected by the angle sensor 150 (step S104).

The processor 401 determines whether or not the angle difference calculated for each of the horizontal angle, the depression angle, and the roll angle is included in a corresponding allowable range (step S105). When the angle difference of any of the horizontal angle, the depression angle, and the roll angle exceeds a corresponding allowable range, i.e., the determination result is negative (NO in step S105), the processor 401 causes correction information (angle based on the angle difference between the installation angle of the radar 100 and the target value of the installation angle) for correcting the installation angle of the radar 100, to be displayed in the determination result display part 530 on the assistance screen 500 (step S106).

FIG. 5A and FIG. 5B are referred to again. The determination result display part 530 is a region for displaying a determination result of determination as to whether or not the differences (angle differences) between the target values displayed in the target value display part 511 and the angles displayed in the detection angle display part 520 are included in the allowable ranges. The determination result display part 530 is disposed so as to be arranged in the vertical direction with respect to the target value input part 510 and the detection angle display part 520. In the examples in FIG. 5A and FIG. 5B, the determination result display part 530 is disposed above the target value input part 510 and the detection angle display part 520. The relationship of disposition between the target value input part 510, the detection angle display part 520, and the determination result display part 530 is not limited to this relationship, and the determination result display part 530 may be disposed below the target value input part 510 and the detection angle display part 520.

The allowable range is an example of a predetermined set range. The set range need not be a range determined by the user. For example, the set range may be a fixed range provided in advance to the radar installation angle adjustment assistance apparatus 400, or may be a range transmitted from a server or an information terminal connected to the radar installation angle adjustment assistance apparatus 400 via a communication network.

FIG. 5A shows an example in which a negative determination result is displayed in the determination result display part 530. When the determination result is negative, correction information 531 is displayed in the determination result display part 530. The correction information 531 is information generated based on each calculated angle difference. The correction information 531 includes a direction in which a correction is to be made and an amount by which a correction is to be made with respect to at least one of the horizontal angle, the depression angle, and the roll angle of the radar 100. In the example in FIG. 5A, the target value of the horizontal angle is 130°, whereas the detection angle of the horizontal angle is 127°, and thus, the angle difference is 3°. Since the allowable range of the horizontal angle is ±1°, the angle difference exceeds the allowable range. The target value of the depression angle is 5°, whereas the detection angle of the depression angle is 4°, and thus, the angle difference is 1°. Since the allowable range of the depression angle is +1°, the angle difference is included in the allowable range. The target value of the roll angle is 0°, whereas the detection angle of the roll angle is −1.2°, and thus, the angle difference is −1.2°. Since the allowable range of the roll angle is ±1°, the angle difference exceeds the allowable range. The correction information 531 includes character information of “Adjustment is insufficient” indicating that the angle adjustment has not been ended, and character information of “Please tilt the radar by 3° in the left direction, 1° downwardly, and 1.2° clockwise.”. Such correction information is generated based on the respective angle differences of 3°, 1°, and −1.2° of the horizontal angle, the depression angle, and the roll angle. The user can correct the installation angle of the radar 100 in accordance with the correction information 531.

FIG. 4 is referred to again. The processor 401 causes the correction information 531 to be displayed in the determination result display part 530, and then returns to step S103. Accordingly, every time angle data is received by the communication I/F 407, an angle difference between the target value and the detection angle for each of the horizontal angle, the depression angle, and the roll angle is calculated, and whether or not the angle difference is included in the corresponding allowable range is determined. When the determination result is negative, the correction information in the determination result display part 530 is updated.

When the angle differences of all of the horizontal angle, the depression angle, and the roll angle are included in the allowable ranges. i.e., the determination result is positive (YES in step S105), the processor 401 causes positive information indicating that the angle differences are included in the allowable ranges, to be displayed in the determination result display part 530 on the assistance screen 500 (step S107).

FIG. 5B is referred to again. FIG. 5B shows an example in which a positive determination result is displayed in the determination result display part 530. When the determination result is positive, positive information 532 is displayed in the determination result display part 530. The positive information 532 is information for notifying the user that the angle adjustment has been ended. The display color of the positive information 532 is different from the display color of the correction information 531. For example, the display color of the correction information 531 is red and the display color of the positive information 532 is green. Since the display color of the positive information 532 is different from the display color of the correction information 531, the user can easily recognize that the display in the determination result display part 530 has been switched from the correction information 531 to the positive information 532.

In the example in FIG. 5B, the target value of the horizontal angle is 130°, whereas the detection angle of the horizontal angle is 129°, and thus, the angle difference is 1°. Since the allowable range of the horizontal angle is ±1°, the angle difference is included in the allowable range. The target value of the depression angle is 5, whereas the detection angle of the depression angle is 4°, and thus, the angle difference is 1°. Since the allowable range of the depression angle is ±1°, the angle difference is included in the allowable range. The target value of the roll angle is 0°, whereas the detection angle of the roll angle is −0.2°, and thus, the angle difference is −0.2°. Since the allowable range of the roll angle is ±1°, the angle difference is included in the allowable range. The positive information 532 includes character information of “OK” indicating that the angle adjustment has been ended, and character information of “Within the allowable ranges.” indicating that the angle differences are included in the allowable ranges. The user can recognize that the adjustment of the installation angle of the radar 100 has been ended, by confirming the positive information 532.

Then, the operation of the radar installation angle adjustment assistance apparatus 400 ends.

### Second Embodiment

[2-1. Radar]

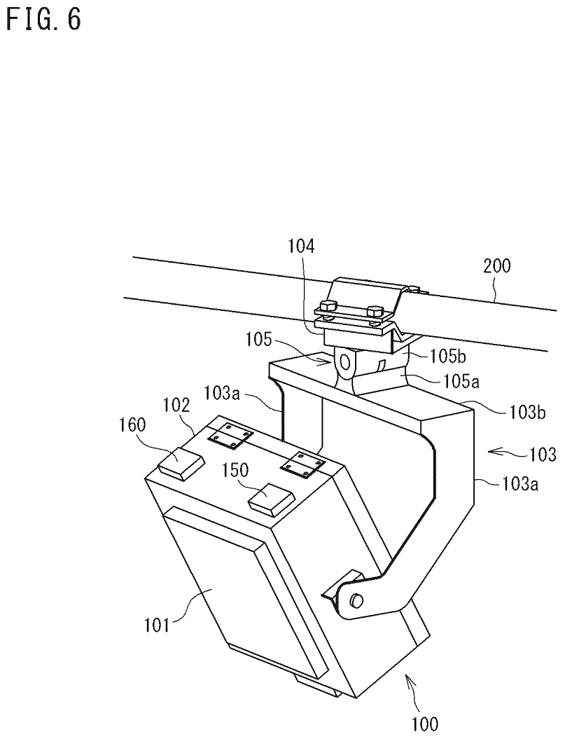

FIG. 6 is a perspective view showing an example of an external configuration of a radar 100 according to a second embodiment. As shown in FIG. 6, not only the angle sensor 150 but also a GNSS (Global Navigation Satellite System) receiver 160 is mounted to the radar body 102. The GNSS receiver 160 is an example of a position sensor. The GNSS receiver 160 receives information transmitted from a plurality of artificial satellites, and acquires, based on the received information, position information (hereinafter, referred to as “installation position information”) of the GNSS receiver 160 (i.e., the radar 100 having the GNSS receiver 160 mounted thereto). The configuration of the radar 100 according to the present embodiment is similar to that of the first embodiment. Thus, the same components are denoted by the same reference signs and description thereof is omitted.

[2-2. Configuration of Radar Installation Angle Adjustment Assistance Apparatus]

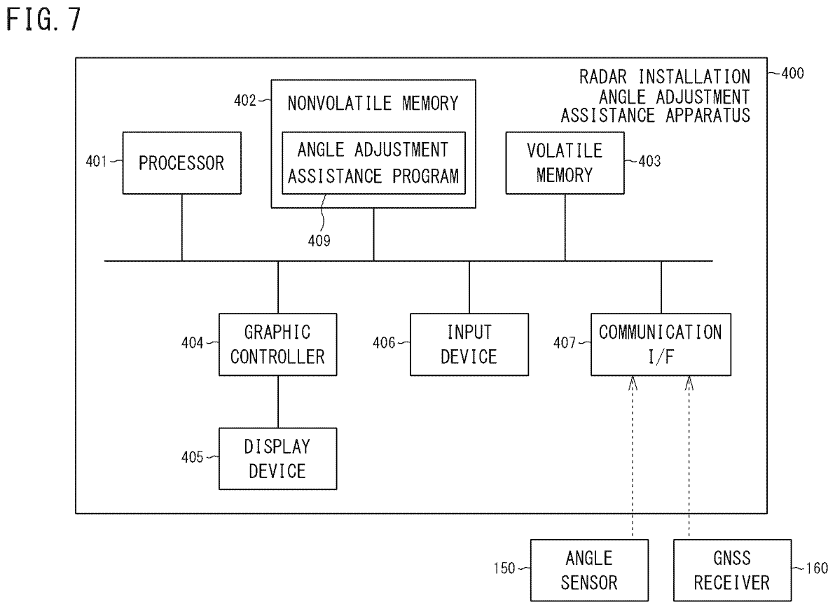

FIG. 7 is a block diagram showing an example of a configuration of a radar installation angle adjustment assistance apparatus according to the second embodiment. In the radar installation angle adjustment assistance apparatus 400 according to the second embodiment, the communication I/F 407 communicates not only with the angle sensor 150 but also with the GNSS receiver 160. The communication I/F 407 can receive the installation position information from the GNSS receiver 160. The configuration of the radar installation angle adjustment assistance apparatus 400 according to the present embodiment is similar to the configuration of the radar installation angle adjustment assistance apparatus 400 according to the first embodiment. Thus, the same components are denoted by the same reference signs and description thereof is omitted.

[2-3. Operation of Radar Installation Angle Adjustment Assistance Apparatus]

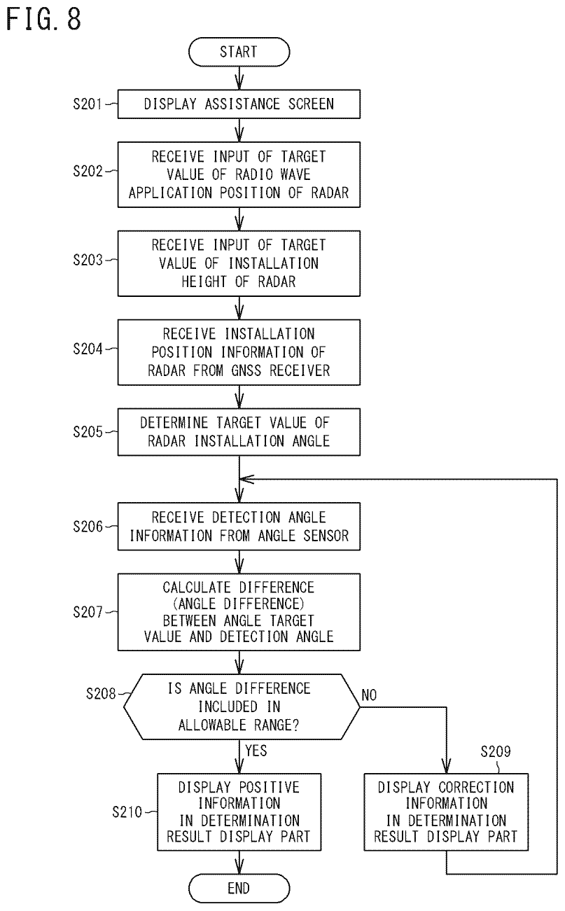

FIG. 8 is a flowchart showing an example of an operation procedure of the radar installation angle adjustment assistance apparatus 400 according to the second embodiment. When the processor 401 has activated the angle adjustment assistance program 409, the radar installation angle adjustment assistance apparatus 400 executes the operation as described below.

The processor 401 causes the display device 405 to display an assistance screen for assisting adjustment of the installation angle of the radar 100 (step S201).

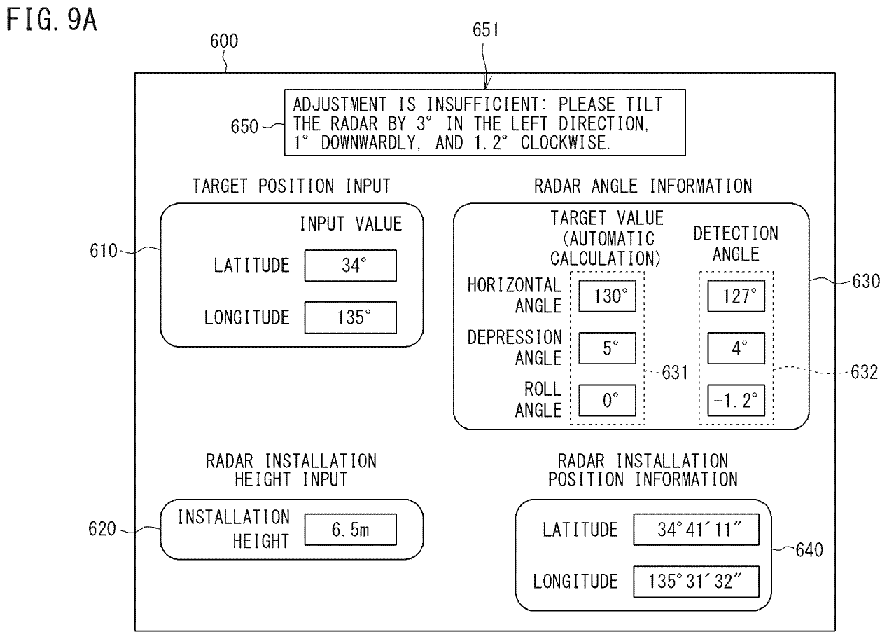

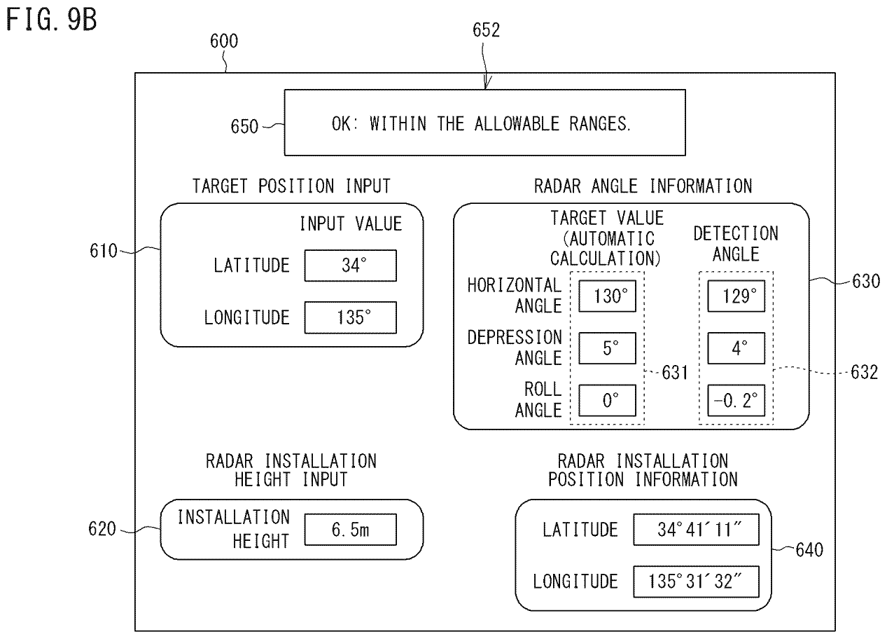

FIG. 9A and FIG. 9B each show an example of an assistance screen according to the second embodiment. As shown in FIG. 9A and FIG. 9B, an assistance screen 600 includes a target position information display part 610, an installation height display part 620, a radar angle information display part 630, an installation position information display part 640, and a determination result display part 650.

The target position information display part 610 is a region for inputting target position information indicating the target value of the radio wave application position of the radar 100 and for displaying the inputted target position information. The radio wave application position is the intersection between the radio wave application axis of the radar 100 and the ground surface. The target position information is, for example, absolute position information, and includes a latitude and a longitude. The target position information display part 610 includes input boxes for respectively inputting a latitude and a longitude. The user can input a latitude and a longitude as the target value of the radio wave application position, into the respective input boxes. The inputted latitude and the longitude are displayed in the respective input boxes.

The installation height display part 620 is a region for inputting the installation height of the radar 100, and for displaying the inputted installation height. The installation height of the radar 100 is the height from the ground surface of the installation position of the radar 100. The installation height display part 620 includes an input box for inputting the installation height. The user can input the installation height into the input box. The inputted installation height is displayed in the input box.

In the present embodiment, the target position information display part 610 and the installation height display part 620 are disposed so as to be arranged in the vertical direction, in a left region of the assistance screen 600. The installation height display part 620 is disposed below the target position information display part 610.

FIG. 8 is referred to again. The user inputs a target value (latitude and longitude) of the radio wave application position of the radar 100, into the target position information display part 610, and inputs the installation height of the radar 100 into the installation height display part 620. The radar installation angle adjustment assistance apparatus 400 receives the target value of the radio wave application position of the radar 100 (step S202), and receives the installation height (step S203).

The GNSS receiver 160 acquires installation position information of the radar 100, and transmits the installation position information. The installation position information includes a latitude and a longitude. The radar installation angle adjustment assistance apparatus 400 receives the installation position information from the GNSS receiver 160 (step S204). The received installation position information is displayed in the installation position information display part 640 on the assistance screen 500.

FIG. 9A and FIG. 9B are referred to again. The installation position information display part 640 is a region for displaying the installation position information (latitude and longitude) of the radar 100. The installation position information display part 640 includes display boxes for latitude and longitude. The latitude and the longitude acquired by the GNSS receiver 160 are displayed in the respective display boxes.

In the present embodiment, the installation height display part 620 and the installation position information display part 640 are disposed so as to be arranged in the lateral direction, in a lower region of the assistance screen 600. The installation position information display part 640 is disposed to the right of the installation height display part 620.

FIG. 8 is referred to again. The processor 401 determines the target value of the installation angle (horizontal angle, depression angle, and roll angle) of the radar 100, based on the target value (latitude and longitude) of the radio wave application position provided from the user, the installation position information (latitude and longitude) of the radar 100 provided from the GNSS receiver 160, and the installation height of the radar 100 provided from the user (step S205). That is, based on the target value of the radio wave application position and the installation position information of the radar 100 detected by the GNSS receiver 160, the distance from the installation position of the radar 100 to the targeted radio wave application position is determined. Based on the calculated distance and the installation height of the radar 100, the target value of the installation angle of the radar 100 is determined. For example, a correspondence table indicating the correspondence relationship between the distance from the installation position of the radar 100 to the targeted radio wave application position, the installation height of the radar 100, and the target value of the installation angle of the radar 100 is stored in the nonvolatile memory 402, and with reference to the correspondence table, the processor 401 can determine a target value of the installation angle of the radar 100. In another example, the processor 401 may calculate a target value of the installation angle of the radar 100, based on the distance from the installation position of the radar 100 to the targeted radio wave application position, and the installation height of the radar 100. The determined target value of the installation angle is displayed in the radar angle information display part 630 on the assistance screen 600.

FIG. 9A and FIG. 9B are referred to again. In the present embodiment, the target position information display part 610 and the radar angle information display part 630 are disposed so as to be arranged in the lateral direction, in a center region in the up-down direction of the assistance screen 600. The radar angle information display part 630 is disposed to the right of the target position information display part 610. Further, the radar angle information display part 630 and the installation position information display part 640 are displayed so as to be arranged in the vertical direction, in a right region of the assistance screen 600. The radar angle information display part 630 is disposed above the installation position information display part 640.

The radar angle information display part 630 includes a target value display part 631 and a detection angle display part 632. The target value display part 631 is a region for displaying the target value of the installation angle of the radar 100. The target value display part 631 includes display boxes for the horizontal angle, the depression angle, and the roll angle. The respective determined target values of the horizontal angle, the depression angle, and the roll angle are displayed in the respective display boxes.

In the target value display part 631, the display boxes for the respective target values of the horizontal angle, the depression angle, and the roll angle are disposed so as to be arranged in order in the vertical direction. Since the arrangement order of the display boxes for the target values of the horizontal angle, the depression angle, and the roll angle is determined, the user is inhibited from confusing the display boxes for the target values between the horizontal angle, the depression angle, and the roll angle.

FIG. 8 is referred to again. The angle sensor 150 detects the horizontal angle, the depression angle, and the roll angle of the radar 100, and transmits angle data. The radar installation angle adjustment assistance apparatus 400 receives the angle data from the angle sensor 150 (step S206). The received detected angles are displayed in the detection angle display part 632 on the assistance screen 600.

FIG. 9A and FIG. 9B are referred to again. The detection angle display part 632 is a region for displaying the angle (horizontal angle, depression angle, and roll angle) detected by the angle sensor 150 provided to the radar 100 having been installed. The detection angle display part 632 includes display boxes for the horizontal angle, the depression angle, and the roll angle. The detection angles of the horizontal angle, the depression angle, and the roll angle detected by the angle sensor 150 are displayed in the respective display boxes.

In the detection angle display part 632, the display boxes for the respective detection angles of the horizontal angle, the depression angle, and the roll angle are disposed so as to be arranged in order in the vertical direction. Since the arrangement order of the display boxes for the detection angles of the horizontal angle, the depression angle, and the roll angle is determined, the user is inhibited from confusing the detection angles between the horizontal angle, the depression angle, and the roll angle. Further, the arrangement order of the display boxes for the detection angles of the horizontal angle, the depression angle, and the roll angle in the detection angle display part 632 and the arrangement order of the input boxes for the target values for the horizontal angle, the depression angle, and the roll angle in the target value display part 631 are unified. Therefore, the user can easily memorize this arrangement order, and can easily confirm the target value and the detection angle of each of the horizontal angle, the depression angle and the roll angle.

The target value display part 631 and the detection angle display part 632 are disposed at positions adjacent to each other in the lateral direction. The display box for the target value of the horizontal angle in the target value display part 631 and the display box for the detection angle of the horizontal angle in the detection angle display part 632 are disposed at positions (i.e., at the same height) adjacent to each other in the lateral direction. The display box for the target value of the depression angle in the target value display part 631 and the display box for the detection angle of the depression angle in the detection angle display part 632 are disposed at positions adjacent to each other in the lateral direction. The display box for the target value of the roll angle in the target value display part 631 and the display box for the detection angle of the roll angle in the detection angle display part 632 are disposed at positions adjacent to each other in the lateral direction. Therefore, the user can easily compare the target value of each of the horizontal angle, the depression angle, and the roll angle, with the detection angle of each of the horizontal angle, the depression angle, and the roll angle.

FIG. 8 is referred to again. The processor 401 calculates the difference between the target value of each of the horizontal angle, the depression angle, and the roll angle provided from the user and the detection value of each of the horizontal angle, the depression angle, and the roll angle detected by the angle sensor 150 (step S207).

The processor 401 determines whether or not the angle difference calculated for each of the horizontal angle, the depression angle, and the roll angle is included in a corresponding allowable range (step S208). In the present embodiment, each allowable range is not inputted by the user into the radar installation angle adjustment assistance apparatus 400, and is stored in advance in the nonvolatile memory 402. When the angle difference of any of the horizontal angle, the depression angle, and the roll angle exceeds a corresponding allowable range, i.e., the determination result is negative (NO in step S208), the processor 401 causes correction information for correcting the installation angle of the radar 100, to be displayed in the determination result display part 650 on the assistance screen 600 (step S209).

FIG. 9A and FIG. 9B are referred to again. The determination result display part 650 is a region for displaying a determination result of determination as to whether or not the differences (angle differences) between the target values displayed in the target value display part 631 and the angles displayed in the detection angle display part 632 are included in the allowable ranges. In the examples in FIG. 9A and FIG. 9B, the determination result display part 650 is disposed above the target position information display part 610 and the radar angle information display part 630. The positional relationship between the target position information display part 610, the installation height display part 620, the radar angle information display part 630, the installation position information display part 640, and the determination result display part 650 on the assistance screen 600 is not limited to that described in the present embodiment.

FIG. 9A shows an example in which a negative determination result is displayed in the determination result display part 650. When the determination result is negative, correction information 651 is displayed in the determination result display part 650. The correction information 651 is similar to the correction information 531 described in the first embodiment, and thus, description thereof is omitted.

FIG. 8 is referred to again. The processor 401 causes the correction information 651 to be displayed in the determination result display part 650, and then returns to step S206. Accordingly, every time angle data is received by the communication I/F 407, an angle difference between the target value and the detection angle for each of the horizontal angle, the depression angle, and the roll angle is calculated, and whether or not the angle difference is included in the corresponding allowable range is determined. When the determination result is negative, the correction information in the determination result display part 650 is updated.

When the angle differences of all of the horizontal angle, the depression angle, and the roll angle are included in the allowable ranges, i.e., the determination result is positive (YES in step S208), the processor 401 causes positive information indicating that the angle differences are included in the allowable ranges, to be displayed in the determination result display part 650 on the assistance screen 600 (step S210).

FIG. 9B is referred to again. FIG. 9B shows an example in which a positive determination result is displayed in the determination result display part 530. When the determination result is positive, positive information 652 is displayed in the determination result display part 650. The positive information 652 is similar to the positive information 652 described in the first embodiment, and thus, description thereof is omitted.

Then, the operation of the radar installation angle adjustment assistance apparatus 400 ends.

[3. Modification]

In the second embodiment, the target value of the installation angle of the radar 100 is determined based on the target value of the radio wave application position of the radar 100, the installation position of the radar 100, and the installation height of the radar 100. However, the present disclosure is not limited thereto. The target value of the installation angle of the radar 100 may be determined, based on the installation height of the radar 100. That is, the distance from the installation position of the radar 100 to the radio wave application position is set to a prescribed value, the radar installation angle adjustment assistance apparatus 400 receives the installation height of the radar 100 from the user or a server, and the target value of the installation angle of the radar 100 may be determined, based on the provided installation height. For example, a correspondence table indicating the correspondence relationship between the installation height of the radar 100 and the target value of the installation angle of the radar 100 may be stored in the nonvolatile memory 402, and with reference to the correspondence table, the processor 401 may specify a target value of the installation angle corresponding to the installation height of the radar 100.

[4. Effect]

The radar installation angle adjustment assistance apparatus 400 according to the embodiments includes the display device 405 and the graphic controller 404. The graphic controller 404 causes the display device 405 to display the assistance screen 500, 600 for assisting adjustment of the installation angle of the radar 100. The assistance screen 500, 600 includes the target value display part 511, 631, the detection angle display part 520, 632, and the determination result display part 530, 650. The target value display part 511, 631 is configured to display the target value of the installation angle of the radar 100. The detection angle display part 520, 632 is configured to display the installation angle of the radar 100 detected by the angle sensor 150 configured to detect the installation angle. The determination result display part 530, 650 is configured to display a determination result of determination as to whether or not the angle difference between the target value displayed in the target value display part 511, 631 and the angle displayed in the detection angle display part 520, 632 is included in an allowable range (a predetermined set range). When the angle difference is outside the allowable range, the graphic controller 404 causes correction information 531, 651 (angle based on the angle difference) to be displayed in the determination result display part 530, 650. The correction information 531, 651 is information for correcting the installation angle of the radar 100. The user can adjust the installation angle of the radar 100 by confirming the correction information 531, 651 on the assistance screen 500, 600. Accordingly, adjustment of the installation angle of the radar 100 by the user can be assisted.

The installation angle of the radar 100 may include at least one of the horizontal angle, the depression angle, and the roll angle of the radar 100. The graphic controller 404 may cause at least one of the horizontal angle, the depression angle, and the roll angle of the radar 100 to be displayed in the detection angle display part 520, 632. Accordingly, adjustment of at least one of the horizontal angle, the depression angle, and the roll angle of the radar 100 can be assisted.

The correction information 531, 651 may include an angle for correcting at least one of the horizontal angle, the depression angle, and the roll angle of the radar 100. The graphic controller 404 may cause the angle for correcting at least one of the horizontal angle, the depression angle, and the roll angle of the radar 100, to be displayed on the assistance screen 500, 600. Accordingly, the user can appropriately correct at least one of the horizontal angle, the depression angle, and the roll angle of the radar 100 by confirming the correction information.

The radar installation angle adjustment assistance apparatus 400 may further include the communication I/F (reception unit) 407. The communication I/F 407 is configured to receive angle data indicating the angle detected by the angle sensor 150. The graphic controller 404 may update display of the correction information 531, 651 every time the angle data is received by the communication I/F 407, and may switch display in the determination result display part 530, 650 from the correction information 531, 651 to the positive information 532, 652 when the angle difference has changed so as to be included in the allowable range. The positive information 532, 652 is information indicating that the angle difference is included in the allowable range. Accordingly, the user can easily and appropriately adjust the installation angle by correcting, in accordance with the assistance screen 500, 600, the installation angle of the radar 100 until the display in the determination result display part 530, 650 is switched from the correction information 531, 651 to the positive information 532, 652.

The display color for displaying the correction information 531, 651 and the display color for displaying the positive information 532, 652 may be different from each other. Accordingly, the user can easily confirm switching from the correction information 531, 651 to the positive information 532, 652 in the determination result display part 530, 650.

The assistance screen 600 may further include the installation height display part 620. The installation height display part 620 is configured to display the installation height of the radar 100. The graphic controller 404 may cause the target value of the installation angle calculated based on the installation height displayed in the installation height display part 620, to be displayed in the target value display part 511, 631. Accordingly, an appropriate target value of the installation angle according to the installation height of the radar 100 can be presented to the user.

The assistance screen 600 may further include the installation position information display part 640 and the target position information display part 610. The installation position information display part 640 is configured to display installation position information indicating the installation position of the radar 100. The target position information display part 610 is configured to display target position information indicating the target value of the radio wave application position of the radar 100. The graphic controller 404 may cause the target value of the installation angle calculated based on the installation position information displayed in the installation position information display part 640, the target position information displayed in the target position information display part 610, and the installation height displayed in the installation height display part 620, to be displayed in the target value display part 511, 631. Accordingly, an appropriate target value of the installation angle according to the installation position of the radar 100, the target value of the radio wave application position of the radar 100, and the installation height of the radar 100 can be presented to the user.

The graphic controller 404 may cause the installation position information indicating the position of the radar 100 detected by the GNSS receiver 160 configured to detect the position, to be displayed in the installation position information display part 640. Accordingly, the target value of the installation angle of the radar 100 can be calculated by using accurate installation position information of the radar 100 detected by the GNSS receiver 160.

[5. Supplementary Note]

The embodiments disclosed herein are merely illustrative in all aspects and are not restrictive. The scope of the present disclosure is defined by the scope of the claims rather than the embodiments described above, and is intended to include meaning equivalent to the scope of the claims and all modifications within the scope.

### REFERENCE SIGNS LIST

100 radar
101 transmission/reception face
102 radar body
103 depression angle adjustment part
103a arm
103b coupling part
104 horizontal angle adjustment part
105 roll angle adjustment part
105a lower member
105b upper member
150 angle sensor
160 GNSS receiver
200 arm
300 target area
400 radar installation angle adjustment assistance apparatus
401 processor
402 nonvolatile memory
403 volatile memory
404 graphic controller
405 display device
406 input device
409 angle adjustment assistance program
500, 600 assistance screen
510 target value input part
511, 631 target value display part
512 allowable range display part
520, 632 detection angle display part
530, 650 determination result display part
531, 651 correction information
532, 652 positive information
610 target position information display part
620 installation height display part
630 radar angle information display part
640 installation position information display part
V vehicle

1. A radar installation angle adjustment assistance apparatus comprising:
a display device; and
a display control unit configured to cause the display device to display an assistance screen for assisting adjustment of an installation angle of an infrastructure radar configured to detect an object present in a target area through transmission and reception of a radio wave, wherein
the assistance screen includes
a target value display part configured to display a target value of the installation angle of the infrastructure radar,
a detection angle display part configured to display the installation angle of the infrastructure radar detected by an angle sensor configured to detect the installation angle, and
a determination result display part configured to display a determination result of determination as to whether or not an angle difference between the target value displayed in the target value display part and the installation angle displayed in the detection angle display part is included in a predetermined set range, and
when the angle difference is outside the predetermined set range, the display control unit causes an angle based on the angle difference to be displayed on the assistance screen.

2. The radar installation angle adjustment assistance apparatus according to claim 1, wherein
the installation angle includes at least one of a horizontal angle, a depression angle, and a roll angle of the infrastructure radar, and
the display control unit causes at least one of the horizontal angle, the depression angle, and the roll angle of the infrastructure radar, to be displayed in the detection angle display part.

3. The radar installation angle adjustment assistance apparatus according to claim 2, wherein
the angle based on the angle difference includes an angle for correcting at least one of the horizontal angle, the depression angle, and the roll angle of the infrastructure radar, and
the display control unit causes the angle for correcting at least one of the horizontal angle, the depression angle, and the roll angle of the infrastructure radar, to be displayed on the assistance screen.

4. The radar installation angle adjustment assistance apparatus according to claim 1, further comprising
a reception unit configured to receive angle data indicating an angle detected by the angle sensor, wherein
the display control unit updates display of the angle based on the angle difference every time the angle data is received by the reception unit, and switches display in the determination result display part from the angle based on the angle difference to positive information indicating that the angle difference is included in the predetermined set range, when the angle difference has changed so as to be included in the set range.

5. The radar installation angle adjustment assistance apparatus according to claim 4, wherein
a display color for displaying the angle based on the angle difference and a display color for displaying the positive information are different from each other.

6. The radar installation angle adjustment assistance apparatus according to claim 1, wherein
the assistance screen further includes an installation height display part configured to display an installation height of the infrastructure radar, and
the display control unit causes the target value of the installation angle calculated based on the installation height displayed in the installation height display part, to be displayed in the target value display part.

7. The radar installation angle adjustment assistance apparatus according to claim 6, wherein
the assistance screen further includes
an installation position information display part configured to display installation position information indicating an installation position of the infrastructure radar, and
a target position information display part configured to display target position information indicating a target value of a radio wave application position of the infrastructure radar, and
the display control unit causes the target value of the installation angle calculated based on the installation position information displayed in the installation position information display part, the target position information displayed in the target position information display part, and the installation height displayed in the installation height display part, to be displayed in the target value display part.

8. The radar installation angle adjustment assistance apparatus according to claim 7, wherein
the display control unit causes the installation position information indicating a position of the infrastructure radar detected by a position sensor configured to detect the position, to be displayed in the installation position information display part.

9. A non-transitory computer-readable storage medium having, stored therein, a computer program for causing a computer including a display device, to execute a process of assisting adjustment of an installation angle of an infrastructure radar configured to detect an object present in a target area through transmission and reception of a radio wave, the process comprising
a process of causing the computer to cause the display device to display an assistance screen for assisting adjustment of the installation angle of the infrastructure radar, wherein
the assistance screen includes
a target value display part configured to display a target value of the installation angle of the infrastructure radar,
a detection angle display part configured to display the installation angle of the infrastructure radar detected by an angle sensor configured to detect the installation angle, and
a determination result display part configured to display a determination result of determination as to whether or not an angle difference between the target value displayed in the target value display part and the installation angle displayed in the detection angle display part is included in a predetermined set range, and
when the angle difference is outside the predetermined set range, an angle based on the angle difference is caused to be displayed on the assistance screen.

10. The non-transitory computer-readable storage medium according to claim 9, wherein
the installation angle includes at least one of a horizontal angle, a depression angle, and a roll angle of the infrastructure radar, and
the process of causing the display device to display the assistance screen causes at least one of the horizontal angle, the depression angle, and the roll angle of the infrastructure radar, to be displayed in the detection angle display part.

11. The non-transitory computer-readable storage medium according to claim 10, wherein
the angle based on the angle difference includes an angle for correcting at least one of the horizontal angle, the depression angle, and the roll angle of the infrastructure radar, and
the process of causing the display device to display the assistance screen causes the angle for correcting at least one of the horizontal angle, the depression angle, and the roll angle of the infrastructure radar, to be displayed on the assistance screen.

12. The non-transitory computer-readable storage medium according to claim 9, wherein
the process of causing the display device to display the assistance screen includes a process of: updating display of the angle based on the angle difference every time angle data indicating a detected angle is provided from the angle sensor; and switching display in the determination result display part from the angle based on the angle difference to positive information indicating that the angle difference is included in the predetermined set range, when the angle difference has changed so as to be included in the set range.

13. The non-transitory computer-readable storage medium according to claim 12, wherein
a display color for displaying the angle based on the angle difference and a display color for displaying the positive information are different from each other.

14. The non-transitory computer-readable storage medium according to claim 9, wherein
the assistance screen further includes an installation height display part configured to display an installation height of the infrastructure radar, and
the process of causing the display device to display the assistance screen causes the target value of the installation angle calculated based on the installation height displayed in the installation height display part, to be displayed in the target value display part.

15. The non-transitory computer-readable storage medium according to claim 14, wherein
the assistance screen further includes
an installation position information display part configured to display installation position information indicating an installation position of the infrastructure radar, and
a target position information display part configured to display target position information indicating a target value of a radio wave application position of the infrastructure radar, and
the process of causing the display device to display the assistance screen causes the target value of the installation angle calculated based on the installation position information displayed in the installation position information display part, the target position information displayed in the target position information display part, and the installation height displayed in the installation height display part, to be displayed in the target value display part.

16. The non-transitory computer-readable storage medium according to claim 15, wherein
the process of causing the display device to display the assistance screen causes the installation position information indicating a position of the infrastructure radar detected by a position sensor configured to detect the position, to be displayed in the installation position information display part.
